(19) United States
(12) Patent Application Publication
(10) Pub. No.: US 2004/0200310 A1
(43) Pub. Date: Oct. 14, 2004

(54) Vehicle steering wheel

(75) Inventors: Gulseppe Cavalli, Saronno(VA) (IT); Michael Lehmann, Aschaffenburg (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/820,400

(22) Filed: Apr. 8, 2004

(30) Foreign Application Priority Data
Apr. 10, 2003 (DE) 203 05 830.5

(51) Int. Cl. B62D 1/04

(52) U.S. Cl. 74/552

(57) ABSTRACT

A vehicle steering wheel comprises a steering wheel rim having a skeleton, whereon several predetermined deformation zones with predetermined deformation directions are defined. A rigid wood casing surrounds the skeleton. The wood casing has an inner side facing the skeleton, and a deformation space is provided in deformation direction between the inner side of the wood casing facing the skeleton and the skeleton in the predetermined deformation zones. The deformation space is greater than a space of the inner side of the wood casing to the skeleton in radial direction in other zones.

### FIELD OF THE INVENTION

The invention relates to a vehicle steering wheel.

### BACKGROUND OF THE INVENTION

Steering wheel rims cased in wood give a vehicle steering wheel a high-quality appearance and a comfortable feel. In addition to steering wheels with a foam casing which is covered by a thin wood veneer layer, steering wheels are also known which have a rigid, solid wood casing consisting for example of two shell parts. This solid wood casing can be formed for example from laminated wood layers, the outer surface of the shells consisting of a veneer layer and of a corresponding lacquering.

If in the case of an accident a vehicle occupant strikes onto the steering wheel, it can happen that the skeleton of the steering wheel suffers a plastic deformation. A three-spoked steering wheel deforms for example in three main deformation zones, namely at the uppermost point of the steering wheel rim (in a position incorporated in the vehicle, hereinafter also designated as “12 o'clock position”), and at the two sections of the steering wheel rim situated furthest laterally (hereinafter also named “3 o'clock” and “9 o'clock” position). At the 12 o'clock position, the steering wheel rim will yield radially inwards, whereas at the 3 o'clock and 9 o'clock positions the skeleton of the steering wheel rim will widen radially outwards. It is important now, with such a deformation of the steering wheel rim, to avoid a destruction of the wood casing.

### BRIEF SUMMARY OF THE INVENTION

It is an object of the invention to present a steering wheel in which this can be achieved in a simple and favourably-priced manner.

This takes place in a vehicle steering wheel comprising a steering wheel rim having a skeleton, where several predetermined deformation zones with predetermined deformation directions are defined on the skeleton. A rigid wood casing surrounds the skeleton. The wood casing has an inner side facing the skeleton, and a deformation space is provided in deformation direction between the inner side of the wood casing facing the skeleton and the skeleton in the predetermined deformation zones. The deformation space is greater than a space of the inner side of the wood casing to the skeleton in radial direction in other zones.

In other words, larger deformation areas are made available to the skeleton of the steering wheel rim in the interior of the wood casing only at discrete sites, so that in the case of an impact, the wood casing does not have to take part in the full plastic deformation of the steering wheel rim. The deformation space is only provided in the known deformation zones. In the other regions, the space between the skeleton of the steering wheel rim and the wood casing can be restricted to the space necessary for the equalization of the different expansion coefficients at different temperature and humidity conditions of the skeleton and the wood casing. The wood casing can partially also lie directly against the skeleton.

The deformation space between the outer side of the skeleton and the inner side of the wood casing preferably amounts to between 1 and 8 mm.

Preferably the wood casing surrounds a ring-shaped chamber in which the skeleton is arranged.

In a first preferred embodiment of the invention, the ring-shaped chamber has an oval, especially elliptical, periphery perpendicular to a rotational axis of the steering wheel. The long axis of the oval or the ellipse, respectively, is arranged here in the direction of the 3 o'clock to 9 o'clock position (in relation to a steering wheel which is positioned for running straight ahead), so that a deformation of the steering wheel rim is easily able to be equalized in all three deformation directions.

In another preferred embodiment of the invention, provision is made that the center point of the ring-shaped chamber is staggered by a deformation space with respect to the center point of the steering wheel rim. Also through this step, the necessary deformation spaces can be provided.

Perpendicular to a rotational axis of the steering wheel the ring-shaped chamber and the steering wheel rim can each have the form of a circular ring and can each be defined by an imaginary circle located at their respective radial mid-point, the imaginary circles having equal circle radii and the center points of the imaginary circles being staggered by a deformation space. The “radial mid-point” is to be understood here as the mid-point of a line between the radial inward and the radial outward periphery of the ring-shaped chamber or the steering wheel rim, respectively. The diameter of the ring-shaped chamber in radial direction has of course to be chosen suitably and is smaller than the diameter of the steering wheel rim.

According to a third preferred embodiment of the invention, the diameter of the ring-shaped chamber, measured in radial direction of the steering wheel, varies along the periphery of the wood casing situated perpendicular to a rotational axis of the steering wheel. Advantageously, the diameter is greatest in the deformation zones, in order to provide the necessary deformation spaces. With this embodiment, the ring-shaped chamber or the wood casing can be optimally adapted to the respective skeleton.

The ring-shaped chamber is preferably constructed so that the spacing between the inner side of the wood casing and the skeleton to the side of the wood casing lying in deformation direction is greater than to the oppositely directed side.

Between the skeleton and the wood casing at least one element of a compressible or elastic material can be arranged. Here, this can be a conventional foaming around of the skeleton. The compressible material can be arranged over the entire periphery of the skeleton, but it is also possible to only cover partial sections of the skeleton.

The wood casing can be composed of at least two shell parts, as is already known for example from the DE 101 33 324 A1.

Preferably, the shell parts of the wood casing are solid, and the ring-shaped chamber taking up the skeleton is formed by a milling out in the shell parts.

### BRIEF DESCRIPTION OF THE DRAWINGS

FIG. 1 shows a diagrammatic view of a steering wheel according to the invention;

FIG. 2 shows a diagrammatic sectional view of a steering wheel according to the invention in accordance with a first embodiment;

FIG. 3 shows a diagrammatic sectional view of the wood casing of FIG. 2;

FIG. 4 shows a diagrammatic sectional view of a steering wheel according to the invention in accordance with a second embodiment;

FIG. 5 shows a diagrammatic sectional view of a steering wheel according to the invention in accordance with a third embodiment; and

FIG. 6 shows a diagrammatic section through the steering wheel rim of FIG. 4 at the 3 o'clock position.

### DETAILED DESCRIPTION OF PREFERRED EMBODIMENTS

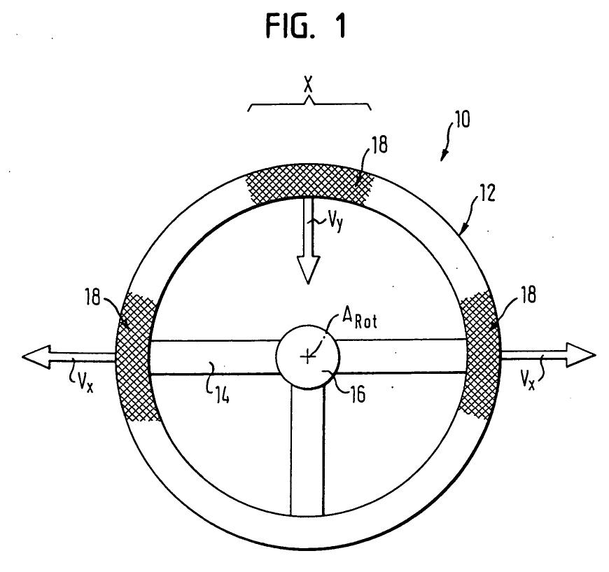

In FIG. 1 a steering wheel 10 is illustrated, with a steering wheel rim 12 and three spokes 14 and a hub region 16, which is connected by the spokes 14 with the steering wheel rim 12.

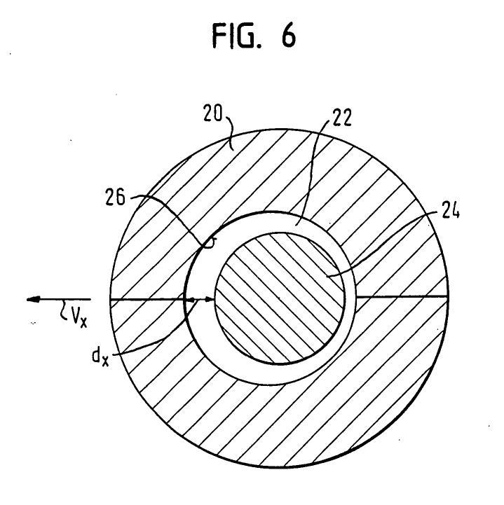

The steering wheel rim has as outermost layer a solid wood casing 20. The wood casing 20 is composed here of two shell parts (see FIG. 6), of which in the following figures respectively only one is illustrated. The wood casing 20 is in itself substantially rigid. It can consist of solid wood, a laminate or another suitable wood material. The surface can be covered with a wood veneer. The invention is, however, independent of the exact design of the wood casing.

In the wood casing 20, a chamber 22 describing a closed ring is formed by milling a groove respectively into the two shell parts, which receives an metal skeleton 24 of the steering wheel rim 12 forming a closed ring. When the wood casing 20 is closed by connecting the shell parts, the skeleton 24 in the form of a circular ring is completely surrounded by the wood casing 20.

The ring-shaped chamber 22 and the skeleton 24 lie in a plane perpendicular to the rotational axis A_{Rot} of the steering wheel 10.

The steering wheel 10 is illustrated in the Figures in a position which it also assumes in its basic position used in the vehicle (running straight ahead). Two of the spokes 14 lie here approximately horizontally, whereas the third spoke 14 runs downwards to the lowest point of the steering wheel 10.

If at all, then the driver of the vehicle is likely to strike onto the zone designated by X on the steering wheel rim 12. Such an impact results in a deformation of the skeleton 24 in this deformation zone 18 (which corresponds to a “12 o'clock position”) by a radially inwardly directed deformation path in direction V_{y} (see arrow). The deformation zones 18 are indicated diagrammatically in FIG. 1. At the same time, the skeleton 24 deforms in two further deformation zones 18 at the two points of the steering wheel rim 12 (“3 o'clock-” or “9 o'clock position”) situated furthest laterally, in a deformation direction Vₓ by a deformation path radially outwards. The deformation paths can amount to up to 15 mm. The deformation paths on the lateral deformation zones are generally somewhat smaller than the deformation path at X.

The elasticity of the wood casing 20 only permits a fraction of such a deformation. According to the invention, therefore, deformation chambers (cavities) are hollowed out in the wood casing 20 on the discrete zones associated with the deformation zones 18, in which deformation chambers, between the outer side of the skeleton 24 and an inner side 26 of the wood casing 20, a deformation space dₓ, d_{y} is provided, which is necessary for equalizing the deformation of the skeleton 24. The deformation space dₓ, d_{y} preferably corresponds to the difference between the deformation path of the skeleton 24 and the elastic deformability of the wood casing 20. After completion of the deformation, the outer side of the skeleton 24 can lie against the inner side 26 of the wood casing 20. However, on no account does a fracture of the wood casing 20 occur through the deformation of the skeleton 24. Outside the discrete zones 18, either distinctly smaller spaces are provided between the skeleton 24 and the inner side 26 of the wood casing 20, or no spacing at all is present, both in order to avoid play.

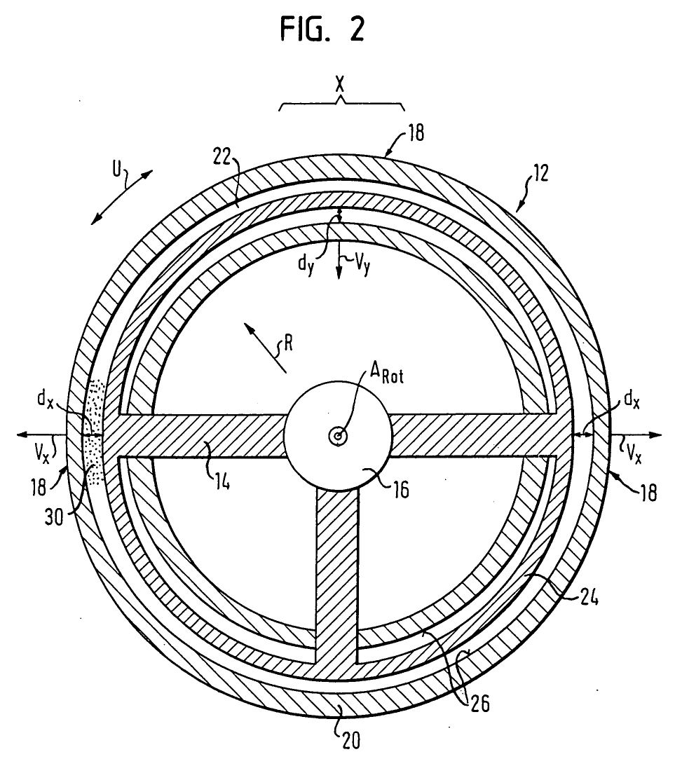

In the first embodiment of the invention illustrated in FIG. 2, the steering wheel rim 12 and its skeleton 24 have a circular shape in the plane perpendicular to the rotational axis A_{Rot}, whereas in the same plane the ring-shaped chamber 22 has an oval circumference, the long axis of the oval being aligned from the 3 o'clock- to the 9 o'clock position.

The eccentricity of the ring-shaped chamber 22 and the arrangement of the long axis of the ring-shaped chamber 22 are selected so that in the three previously-mentioned deformation zones 18, respectively the deformation space dₓ, d_{y} is available for the skeleton 24 in deformation direction Vₓ, V_{y}. In the other zones, in which such a deformation space is not necessary, the space between skeleton 24 and inner side 26 of the wood casing 20 is mostly smaller. Owing to the symmetry relationships, also at the lowest point of the steering wheel 10, a space corresponding to d_{y} is formed. This space is, however, unimportant for the function of the steering wheel 10.

In the example illustrated here, the diameter of the ring-shaped chamber 22 in a section plane in radial direction R is identical over the entire circumference U of the steering wheel rim 12. However, it is also conceivable to vary the diameter, as is further described later.

The skeleton 24 is fastened in the wood casing 20 in a known manner, e.g. by clips or spacers. It is also possible to provide a surrounding foam between the skeleton and the inner side 26 of the wood casing 20, which surrounds the skeleton 24 and fills the ring-shaped chamber. During a foaming process for the introduction of the surrounding foam in the ring-shaped chamber 22, the skeleton can be fixed in the desired position by centering pins (not shown) which, for example, engage into the skeleton base. In the finished steering wheel, the fixing of the skeleton can take place solely by means of the surrounding foam which extends between the skeleton 24 and the inner side 26 of the wood casing.

If a surrounding foam also extends in the deformation zones 18, it must be constructed so as to be at least compressible there. It is also possible to insert special compressible elements 30 in the deformation zones 18 (indicated in FIG. 2). The elements 30 are compressed in the deformation of the steering wheel rim skeleton 24. The material of the elements 30 must have such a high stability that in the normal operating of the steering wheel, the skeleton 24 can not move with respect to the wood casing 20.

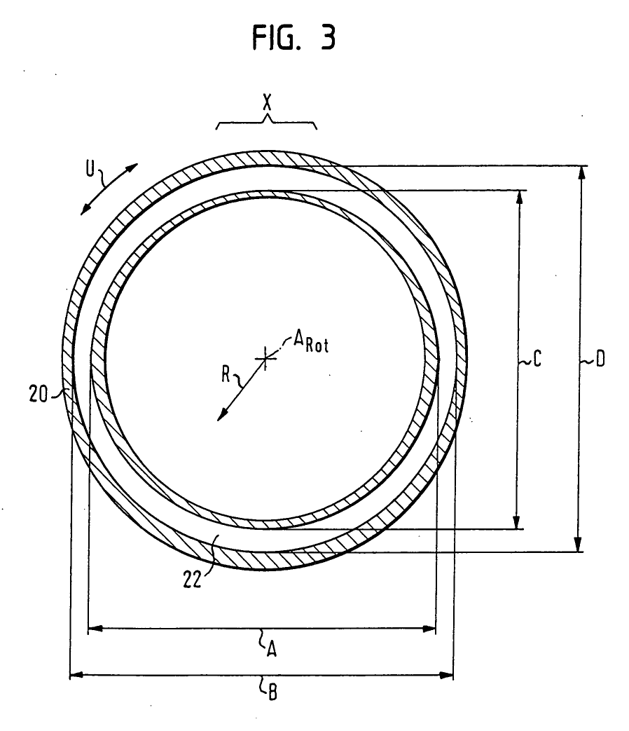

FIG. 3 shows diagrammatically the ring-shaped chamber 22 in the wood casing 20 in a section perpendicular to the rotational axis A_{Rot}. The ring-shaped chamber 22 shown has an oval, especially elliptical, shape in this plane. The inner sides of the wood casing 20 limiting the ring-shaped chamber 22 also form in this section two ellipses which are oriented concentrically with each other. The longest and shortest diameter of the ellipses along their respective long and short axes (major and minor axis) are designated with A to D. Here applies that the diameters A, B along the long axes in the direction from the 3 o'clock position to the 9 o'clock position are greater than the diameters C, D along the short axes in the direction from the 12 o'clock position to the 6 o'clock position.

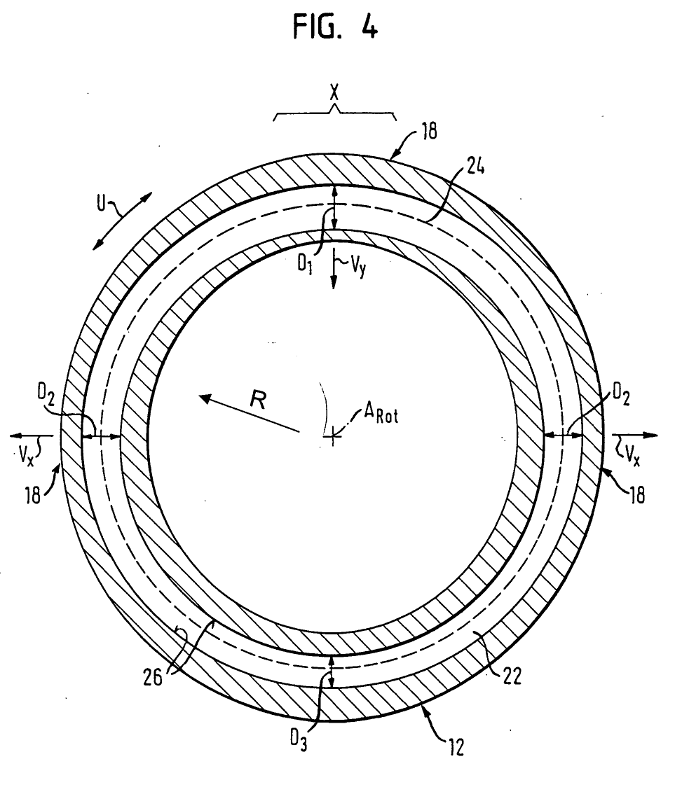

FIG. 4 shows a second embodiment of the invention, in which the diameter of the ring-shaped chamber 22 in a section in radial direction R varies along the circumference U in the plane perpendicular to the rotational axis A_{Rot}. In the deformation zones 18, the diameter in the radial direction R is so great that in deformation direction Vₓ, V_{y} the space between the inner side 26 of the wood casing 20 and the skeleton 24 (indicated by the dashed line) corresponds to the deformation path dₓ, d_{y}, whereas it is smaller outside the deformation zones 18 (see also FIG. 6). The ring-shaped chamber 22 can have the smallest diameter at the lowermost site of the steering wheel. In the example shown here, the diameter D₁ of the ring-shaped chamber 22 provided at the 12 o'clock position is greater than the diameter D₂ provided at the 3 o'clock- or 9 o'clock position. The diameter D₃ of the ring-shaped chamber 22 is smallest at the 6 o'clock position. According to the given relationships, the diameter D₁ at the 12 o'clock position could also be equal to the diameter D₂ at the 3 o'clock- or 9 o'clock position. Through the adaptation, in line with specific objectives, of the diameter of the ring-shaped chamber 22 along the circumference U, an optimum adaptation of the wood casing 20 to the deformation behaviour of the steering wheel skeleton 24 can be achieved.

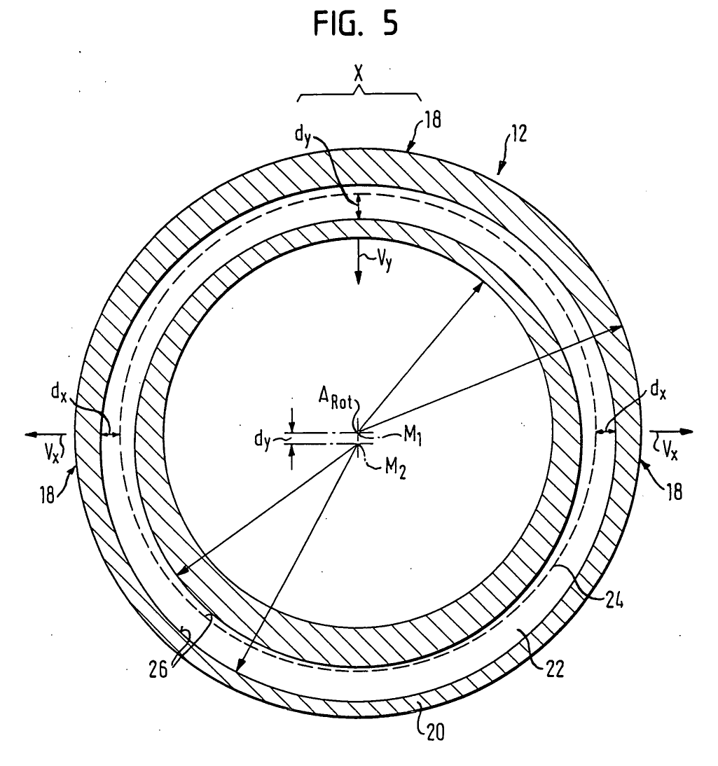

In the third embodiment of the invention shown in FIG. 5, the ring-shaped chamber 22 is constructed in a circular shape in the plane perpendicular to the rotational axis A_{Rot}, the center M₂ of the circle of the ring-shaped chamber 22 being shifted downwards, however, by the deformation space d_{y} with respect to the center M₁ of the circle of the skeleton 24 (which lies on the rotational axis A_{Rot} of the steering wheel). Considering an imaginary circle located at the radial mid-points of the ring-shaped chamber 22 and the steering wheel rim 12, respectively, their circle radii will be equal, whereas their center points M₁, M₂ will be shifted with respect to each other.

By the staggering between ring-shaped chamber 22 and skeleton 24, likewise the necessary deformation spaces dₓ, d₁ are produced between the inner side 26 of the wood casing 20 and the skeleton 24.

Also in this embodiment, at the lower end of the steering wheel a further spacing d_{y} is formed which, however, is unimportant for the function of the steering wheel.

The ring-shaped chamber 22 and the skeleton 24 are coordinated with each other in the embodiments according to FIGS. 4 and 5 so that the skeleton 24 lies with its radially inwardly-directed surface in the 6 o'clock zone on the inner side of the ring-shaped chamber 22.

All the features described in connection with the various embodiments of the invention can be exchanged for each other or combined with each other as desired, at the discretion of the specialist in the art.

1. A vehicle steering wheel comprising:
a steering wheel rim (12) having a skeleton (24), several predetermined deformation zones (18) with predetermined deformation directions (Vₓ, V_{y}) being defined on said skeleton (24),
and a rigid wood casing (20) surrounding said skeleton (24), said wood casing (20) having an inner side (26) facing said skeleton (24),
a deformation space (dₓ, d_{y}) being provided in said deformation direction (Vₓ, V_{y}) between said inner side (26) of said wood casing (20) facing said skeleton (24) and said skeleton (24) in said predetermined deformation zones (18),
said deformation space (dₓ, d_{y}) being greater than a space between said inner side (26) of said wood casing (20) and said skeleton (24) in radial direction (R) in other zones.

2. The vehicle steering wheel according to claim 1, wherein said deformation space (dₓ, d_{y}) between said skeleton (24) and said inner side (26) of said wood casing (20) amounts to between 1 and 8 mm.

3. The vehicle steering wheel according to claim 1, wherein said wood casing (20) surrounds a ring-shaped chamber (22) in which said skeleton (24) is arranged.

4. The vehicle steering wheel according to claim 3, wherein a center point (M₂) of said ring-shaped chamber (22) is staggered with respect to a center point (M₁) of said steering wheel rim (12) by a deformation space (d_{y}).

5. The vehicle steering wheel according to claim 1, wherein, seen in a plane perpendicular to a rotational axis (A_{Rot}) of said steering wheel (10), said ring-shaped chamber (22) and said steering wheel rim (12) each have a form of a circular ring and are each defined by an imaginary circle located at their respective radial mid-point, said imaginary circles having equal circle radii and the center points (M₁, M₂) of said imaginary circles being staggered by a deformation space (d_{y}).

6. The vehicle steering wheel according to claim 3, wherein said ring-shaped chamber (22) has an oval periphery perpendicular to a rotational axis (A_{Rot}) of said steering wheel (10).

7. The vehicle steering wheel according to claim 3, wherein a diameter of said ring-shaped chamber (22), measured in radial direction (R) of said steering wheel (10), varies along a circumference (U) of said wood casing (20) situated perpendicular to a rotational axis (A_{Rot}) of said steering wheel (10).

8. The vehicle steering wheel according to claim 7, wherein said diameter of said ring-shaped chamber (22) is greatest in said deformation zones (18).

9. The vehicle steering wheel according to claim 1, wherein between skeleton (24) and wood casing (20) at least one element (30) of a compressible material is arranged.

10. The vehicle steering wheel according to claim 1, wherein said wood casing (20) is composed of at least two shell parts.

11. The vehicle steering wheel according to claim 10, wherein said shell parts of said wood casing (20) are solid and a ring-shaped chamber (22) taking up said skeleton (24) is formed by a milling out in said shell parts.
